(19) United States
(12) Patent Application Publication
(10) Pub. No.: US 2021/0159539 A1
(43) Pub. Date: May 27, 2021

(54) NONAQUEOUS-ELECTROLYTE SECONDARY CELL

(71) Applicant: Panasonic Intellectual Property Management Co., Ltd., Osaka-shi, Osaka (JP)

(72) Inventors: Masahiro Shiraga, Osaka (JP); Yuanlong Zhong, Osaka (JP)

(73) Assignee: Panasonic Intellectual Property Management Co., Ltd., Osaka-shi, Osaka (JP)

(21) Appl. No.: 17/045,571

(22) PCT Filed: Feb. 18, 2019
(86) PCT No.: PCT/JP2019/005820

§ 371 Date: Oct. 6, 2020

(30) Foreign Application Priority Data
Apr. 16, 2018 (JP) 2018-078694

(51) Int. Cl. H01M 10/0567; H01M 4/587

(52) U.S. Cl. CPC H01M 10/0567; H01M 10/0525; H01M 4/587

(57) ABSTRACT

A nonaqueous-electrolyte secondary cell according to one embodiment of the present disclosure comprises a positive electrode, a negative electrode, and a nonaqueous electrolyte. The negative electrode contains graphite having a BET specific surface area of 2 m²/g or less, and the nonaqueous electrolyte contains a cyclic carboxylic acid anhydride represented by formula (1) or formula (2). In the formula (1), n represents 0, 1, or 2, and R₁ to R₄ each independently represents a hydrogen atom, an alkyl group, an alkenyl group, or an aryl group. In the formula (2), R₅ to R₈ each independently represents a hydrogen atom, an alkyl group, an alkenyl group, or an aryl group.

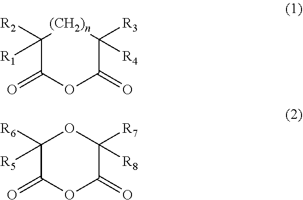

### TECHNICAL FIELD

The present invention relates to a non-aqueous electrolyte secondary battery.

### BACKGROUND

In recent years, as a secondary battery with high output and high energy density, a non-aqueous electrolyte secondary battery has been widely used, the battery comprising a positive electrode, a negative electrode, and a non-aqueous electrolyte wherein lithium ions are transferred between the positive electrode and the negative electrode to perform charge and discharge.

For example. Patent Literature 1 discloses: graphite particles that are powder of a mixture containing a graphitizable aggregate or graphite, and a graphitizable binder, produced by producing mixture particles to be subjected to a treatment in which the particles do not fuse to each other in the step of firing and graphitizing and then firing and graphitizing the particles, and have a specific surface area of 1.0 to 3.0 m²/g; and a negative electrode for lithium secondary battery containing the graphite particles.

### CITATION LIST

### Patent Literature

Patent Literature 1: JP 2013-182807 A

### SUMMARY

### Technical Problem

Patent Literature 1 states that the charge-discharge cycle characteristics are improved by using graphite having a low specific surface area for a negative electrode. However, a battery using graphite having a low specific surface area is problematic in that an increase in internal resistance is larger than that in the case of using the conventional graphite.

An object of the present disclosure is to provide a non-aqueous electrolyte secondary battery capable of improving charge-discharge cycle characteristics and suppressing an increase in internal resistance.

### Solution to Problem

The non-aqueous electrolyte secondary battery according to an aspect of the present disclosure includes a positive electrode, a negative electrode, and a non-aqueous electrolyte, wherein the negative electrode contains graphite having a BET specific surface area of 2 m²/g or less, and the non-aqueous electrolyte contains a cyclic carboxylic anhydride represented by the following formula (1) or formula (2):

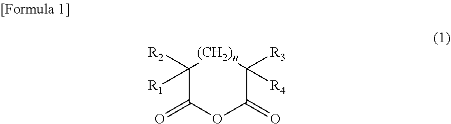

wherein in the formula (1), n represents 0, 1, or 2, and R₁ to R₄ each independently represent a hydrogen atom, an alkyl group, an alkenyl group, or an aryl group,

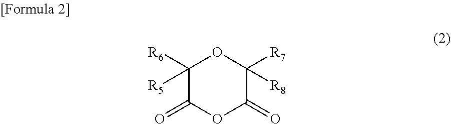

wherein in the formula (2). R₅ to R₈ each independently represent a hydrogen atom, an alkyl group, an alkenyl group, or an aryl group.

### Advantageous Effects of Invention

The non-aqueous electrolyte secondary battery according to an aspect of the present disclosure can improve charge-discharge cycle characteristics and suppress an increase in internal resistance.

### DESCRIPTION OF EMBODIMENTS

It is considered that charge-discharge cycle characteristics of the conventional non-aqueous electrolyte secondary battery using graphite having a low specific surface area as a negative electrode active material are improved because the low specific surface area of graphite decreases the area of graphite expanding and contracting with intercalation/deintercalation of lithium ions to suppress the side reaction between graphite and the non-aqueous electrolyte. However, using graphite having a low specific surface area increases the amount of lithium ions intercalated/deintercalated per unit area on the graphite surface, and therefore the film (SEI film) formed on the negative electrode becomes thicker. As a result, a battery using graphite having a low specific surface area may cause a larger increase in internal resistance than that in the case of using the conventional graphite.

As a result of intensive investigations by the present inventors, it has been found that in the non-aqueous electrolyte secondary battery containing graphite having a BET specific surface area of 2 m²/g or less in the negative electrode, addition of a cyclic carboxylic anhydride represented by the following formula (1) or formula (2) to the non-aqueous electrolyte improves charge-discharge cycle characteristics and suppresses an increase in internal resistance,

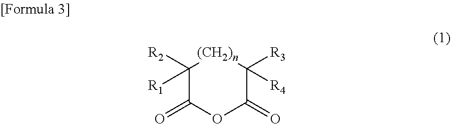

wherein in the formula (1), n represents 0, 1, or 2, and R₁ to R₄ each independently represent a hydrogen atom, an alkyl group, an alkenyl group, or an aryl group,

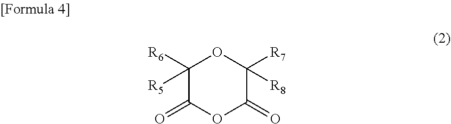

wherein in the formula (2), R₅ to R₈ each independently represent a hydrogen atom, an alkyl group, an alkenyl group, or an aryl group.

The mechanism of suppressing the increase in internal resistance while maintaining the charge-discharge cycle characteristics by adding a cyclic carboxylic anhydride to the non-aqueous electrolyte is not sufficiently clear, and the following estimation is possible, for instance. In a non-aqueous electrolyte secondary battery comprising a non-aqueous electrolyte containing a cyclic carboxylic anhydride, it is considered that a film (SEI film) derived from a component contained in the non-aqueous electrolyte is formed on the negative electrode during charge and discharge. It is considered that this film becomes a strong film by containing a constituent component derived from the ring-opening polymerization of the cyclic carboxylic anhydride, and suppresses the decomposition of the non-aqueous electrolyte during charge and discharge. In addition, it is considered that the carbonyl group derived from the cyclic carboxylic anhydride increases the lithium ion conductivity of the film, thereby suppressing decomposition of the non-aqueous electrolyte due to intercalation/deintercalation of lithium ions. As a result, it can be presumed that graphite having a low specific surface area suppresses the destruction and reformation of the film due to the expansion and contraction of graphite, thus suppressing the increase in the resistance value of the negative electrode at charge and discharge in the non-aqueous electrolyte secondary battery.

Hereinafter, embodiments of the non-aqueous electrolyte secondary battery according to an aspect of the present disclosure will be described. The embodiment described below is an example and the present disclosure is not limited thereto.

A non-aqueous electrolyte secondary battery, which is an example of the embodiment, comprises a positive electrode, a negative electrode, a non-aqueous electrolyte, a separator, and a battery case. Specifically, the non-aqueous electrolyte secondary battery has a structure in which a wound electrode assembly obtained by winding the positive electrode and the negative electrode via the separator and the non-aqueous electrolyte are accommodated in the battery case. The electrode assembly is not limited to the wound electrode assembly, and electrode assemblies in other forms such as a laminated electrode assembly with the positive electrode and the negative electrode laminated via the separator may be applied.

Examples of the battery case accommodating the electrode assembly and the non-aqueous electrolyte include a metal case which is cylindrical, square, coin-shaped, button-shaped or the like and a resin case (laminated battery) obtained by molding a sheet of metal foil laminated with a resin sheet.

Hereinafter, a positive electrode, a negative electrode, a non-aqueous electrolyte, and a separator used for a non-aqueous electrolyte secondary battery, which is an example of the embodiments, will be described in detail.

### [Positive Electrode]

A positive electrode is composed of, for example, a positive electrode current collector such as a metal foil and a positive electrode active material layer formed on the positive electrode current collector. The positive electrode current collector that can be used is a foil of a metal stable in the potential range of the positive electrode such as aluminum, a film in which the metal is disposed on the surface, or the like. The positive electrode active material layer contains, for example, a positive electrode active material, a binder, and a conductive material.

The positive electrode can be obtained, for example, by applying a positive electrode mixture slurry containing a positive electrode active material, a conductive material, and a binder on the positive electrode current collector and drying it to form the positive electrode active material layer on the positive electrode current collector and by rolling the positive electrode active material layer. The thickness of the positive electrode current collector is not particularly limited, and is, for example, about 10 μm or more and 100 μm or less.

The positive electrode active material layer contains a positive electrode active material composed of a lithium transition metal oxide. Examples of the lithium transition metal oxide include lithium (Li) and lithium transition metal oxides containing transition metal elements such as cobalt (Co), manganese (Mn), and nickel (Ni). The lithium transition metal oxide may contain other additive elements other than Co, Mn, and Ni, and examples thereof include aluminum (Al), zirconium (Zr), boron (B), magnesium (Mg), scandium (Sc), yttrium (Y), titanium (Ti), iron (Fe), copper (Cu), zinc (Zn), chromium (Cr), lead (Pb), tin (Sn), sodium (Na), potassium (K), barium (Ba), strontium (Sr), calcium (Ca), tungsten (W), molybdenum (Mo), niobium (Nb), and silicon (Si).

Specific examples of the lithium transition metal oxide include LiₓCoO₂, LiₓNiO₂, LiₓMnO₂, LiₓCo_{y}Ni_{1-y}O₂, LiₓCo_{y}M_{1-y}Oz, LiₓNi_{1-y}MyOz, LiₓMn₂O₄, LiₓMn_{2-y}MyO₄, LiMPO₄, and Li₂MP4F (in each chemical formula, M is at least one of Na, Mg, Sc, Y, Mn, Fe, Co, Ni, Cu, Zn, Al, Cr, Pb, Sb, and B, and 0<x≤1.2, 0<y≤0.9, and 2.0≤z≤2.3). These lithium transition metal oxides may be used singly or two or more thereof may be mixed and used.

The conductive material that can be used is a known conductive material that enhances the electrical conductivity of the positive electrode mixture layer, and examples thereof include carbon powders such as carbon black, acetylene black, Ketjen black, and graphite. These may be used singly or in combination of two or more.

The binder that can be used is a known binder that maintains a good contact condition of the positive electrode active material and the conductive material and that enhances the binding property of the positive electrode active material and the like on the surface of the positive electrode current collector, and examples thereof include fluorine-based polymers and rubber-based polymers. Examples of the fluorine-based polymer include polytetrafluoroethylene (PTFE), polyvinylidene fluoride (PVdF), and modified products thereof, and examples of the rubber-based polymer include ethylene-propylene-isoprene copolymer and ethylene-propylene-butadiene copolymer. These may be used singly or in combination of two or more. In addition, the binder may be used in combination with a thickener such as carboxymethyl cellulose (CMC) or polyethylene oxide (PEO).

### [Negative Electrode]

The negative electrode is composed of, for example, a negative electrode current collector, such as a metal foil, and a negative electrode active material layer formed on the negative electrode current collector. The negative electrode current collector that can be used is a foil of metal that is stable in the potential range of the negative electrode such as copper, a film in which the metal is disposed on the surface layer, or the like. The negative electrode active material layer contains, for example, a negative electrode active material, a binder, and a thickener.

The negative electrode can be produced, for example, by applying a negative electrode mixture slurry containing the negative electrode active material, the binder, and the thickener on the negative electrode current collector, drying the film, and then rolling to form the negative electrode active material layer on both surfaces of the current collector. The thickness of the negative electrode current collector is preferably 5 μm or more and 40 μm or less, and more preferably 10 μm or more and 20 μm or less from the viewpoints such as current collecting properties and mechanical strength.

The negative electrode active material layer according to the present disclosure comprises graphite having a BET specific surface area of 2 m²/g or less as a negative electrode active material that involves occlusion/release of lithium ions. It is thus considered that using graphite having a BET specific surface area of 2 m²/g or less as the negative electrode active material suppresses side reaction with the non-aqueous electrolyte and improves the charge-discharge cycle characteristics of the non-aqueous electrolyte secondary battery. The BET specific surface area of graphite is preferably 1.8 m²/g or less, and more preferably 1.5 m²/g or less. The lower limit of the BET specific surface area is not particularly limited, and from the viewpoint of acceptability of lithium ions, it may be 0.1 m²/g or more, and is preferably 0.4 m²/g or more. The BET specific surface area of graphite may be measured by a known method, and for example, the measurement is performed based on the BET method by using a specific surface area measuring apparatus (Macsorb(R) HM model-1201, manufactured by Mountech Co., Ltd.).

As graphite having a BET specific surface area of 2 m²/g or less, graphite-based materials that have been conventionally used as a negative electrode active material of the non-aqueous electrolyte secondary battery may be used, and examples thereof include natural graphite such as lump graphite and earth graphite and artificial graphite such as lump artificial graphite and graphitized mesophase carbon microbeads.

The graphite having a BET specific surface area of 2 m²/g or less can be obtained, for example, by suppressing the exposure of the edge surface of the graphite crystal and thus preparing graphite having a reduced specific surface area. Examples of the method for suppressing the exposure of the edge surface of the graphite crystal include methods of applying an impact to the graphitized product that has been subjected to a graphite treatment, or applying a shearing force, and specific examples of the method include a method of pulverizing the graphitized product in an inert atmosphere. A hammer mill, a pin mill, a jet mill, or the like can be used in the pulverizing method. In addition, there is a method of coating the surface of graphite with a coal-based or petroleum-based pitch, further performing heat treatment, and coating the exposed edge surface with a carbonized product of the pitch. In addition, in the step for producing graphite, the pulverizing treatment is performed before the heat treatment (graphite treatment) of the carbon material or the like as a raw material, and a predetermined particle size distribution is obtained and then the heat treatment is performed, thereby allowing the exposure of the edge surface of the graphite crystal to be suppressed. The temperature of the heat treatment may be within the range of the temperature of the conventional graphite treatment, and may be, for example, 1800° C. to 3000° C. In addition, not only these artificial graphites but also natural graphites having a specific surface area within the range of the present disclosure may be used.

The volume average particle size of graphite having a BET specific surface area of 2 m²/g or less is, for example, 5 μm or more and 30 μm or less, and preferably 10 μm or more and 25 μm or less. The volume average particle size is a volume average particle size of the negative electrode active material measured by the laser diffraction scattering method, and means the particle size at which the volume integrated value is 50% in the particle size distribution. The volume average particle size of the negative electrode active material may be measured by using, for example, a laser diffraction/scattering particle size distribution measuring apparatus, manufactured by Microtrac Bell Co., Ltd.

The negative electrode mixture layer may contain: materials other than graphite having a BET specific surface area of 2 m²/g or less as the negative electrode active material, such as metallic lithium and lithium alloys including lithium-aluminum alloy, lithium-lead alloy, lithium-silicon alloy, and lithium-tin alloy; carbon materials such as graphite having a BET specific surface area of more than 2 m²/g, coke, and burned organic materials; and metal oxides such as SnO₂, SnO, and TiO₂. From the viewpoint of suppressing the expansion and contraction of the negative electrode mixture layer during the charge-discharge cycle and preventing the destruction of the film formed on the negative electrode active material, the graphite having a BET specific surface area of 2 m²/g or less preferably has 50% by mass or more and more preferably 75% by mass or more based on the total amount of the negative electrode active material.

As the binder, for example, as in the case of the positive electrode, a fluorine-based polymer or a rubber-based polymer may be used, and styrene-butadiene copolymer (SBR) or modified product thereof may also be used.

Examples of the thickener include carboxymethyl cellulose (CMC) and polyethylene oxide (PEO). These may be used singly or in combination of two or more.

### [Non-Aqueous Electrolyte]

The non-aqueous electrolyte contains a non-aqueous solvent and an electrolyte salt dissolved in the non-aqueous solvent, and further contains a cyclic carboxylic anhydride represented by the formula (1) or formula (2) described below. As the non-aqueous solvent used for the non-aqueous electrolyte, for example, esters, ethers, nitriles, and amides such as dimethylformamide and a mixed solvent of two or more of these can be used, and a halogen-substituted product obtained by substituting at least a part of hydrogen in these solvents with a halogen atom such as fluorine can also be used. These may be used singly or in combination of two or more. In addition, the non-aqueous electrolyte is not limited to a liquid electrolyte (non-aqueous electrolyte solution), and may be a solid electrolyte with a gel-like polymer or the like.

Examples of the esters contained in the non-aqueous electrolyte include cyclic carbonates, chain carbonates, and carboxylic acid esters. Examples of the cyclic carbonates include ethylene carbonate (EC), propylene carbonate (PC), and butylene carbonate. Examples of the chain carbonates include dimethyl carbonate (DMC), ethyl methyl carbonate (EMC), diethyl carbonate (DEC), methyl propyl carbonate, ethyl propyl carbonate, and methyl isopropyl carbonate.

Examples of the carboxylic acid esters include methyl acetate, ethyl acetate, propyl acetate, methyl propionate (MP), ethyl propionate, γ-butyrolactone (GBL), and γ-valerolactone (GVL).

Examples of the cyclic ethers contained in the non-aqueous electrolyte include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether.

Examples of the chain ethers contained in the non-aqueous electrolyte include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimetboxymethane, 1,1-diethoxyethane, triethylene glycol dimethyl ether, and tetraethylene glycol dimethyl ether.

Examples of the nitriles contained in the non-aqueous electrolyte include acetonitrile, propionitrile, butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile.

Examples of the halogen-substituted product contained in the non-aqueous electrolyte include a fluorinated cyclic carboxylic acid ester such as 4-fluoroethylene carbonate (FEC), and a fluorinated chain carboxylic acid ester such as fluorinated chain ester carbonate and methyl 3,3,3-trifluoropropionate (FMP).

The electrolyte salt contained in the non-aqueous electrolyte is preferably a lithium salt. The lithium salt may be a supporting salt generally used in the conventional non-aqueous electrolyte secondary battery. Examples of the lithium salt include: LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CₙF₂ₙ₊₁)ₓ (1≤x≤6, n is 1 or 2), LiB₁₀Cl₁₀, LiCl, LiBr, LiI, lithium chloroborane, lower aliphatic lithium carboxylate: borates such as Li₂B₄O₇, Li[B(C₂O₄)₂](lithium-bisoxalate borate (LiBOB)), Li[B(C₂O₄)F₂]; Li[P(C₂O₄)F₄], Li[P(C₂O₄)₂F₂]; and imide salts such as LiN(FSO₂)₂, LiN(CₗF₂ₗ₊₁SO₂)(CₘF₂ₘ₊₁SO₂)(l and m are each an integer of 0 or more). These lithium salts may be used singly or two or more thereof may be mixed and used.

The cyclic carboxylic anhydride contained in the non-aqueous electrolyte is not particularly limited as long as it is represented by the formula (1) or formula (2). In the formula (1), n represents 0, 1 or 2, R₁ to R₄ each independently represent a hydrogen atom, an alkyl group, an alkenyl group, or an aryl group, and in the formula (2), R₅ to R₈ each independently represent a hydrogen atom, an alkyl group, an alkenyl group, or an aryl group.

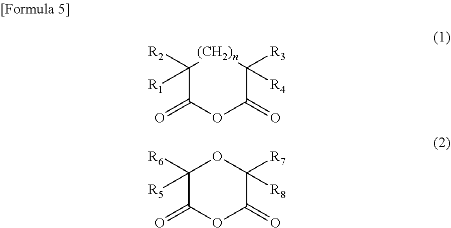

In the formula (1), n is preferably 0 or 1. The case where n is 0 means that the carbon atom having R₁ and R₂ and the carbon atom having R₃ and R₄ are directly bound to each other to form a 5-membered ring.

The alkyl group represented by R₁ to R₈ is, for example, an alkyl group having 1 to 5 carbon atoms such as a methyl group or an ethyl group, the alkenyl group represented by R₁ to R₈ is, for example, a alkenyl group having 2 to 5 carbon atoms such as a vinyl group, a propenyl group, or an allyl group, and the aryl group represented by R₁ to R₈ is, for example, an aryl group having 6 to 10 carbon atoms such as a phenyl group or a benzyl group. R₁ to R₈ are preferably selected from the group consisting of a hydrogen atom, an alkyl group having 1 to 3 carbon atoms, an alkenyl group having 2 to 3 carbon atoms, and a phenyl group, and more preferably selected from the group consisting of a hydrogen atom, a methyl group, an ethyl group, and a vinyl group.

Specific examples of the cyclic carboxylic anhydrides represented by the formula (1) or formula (2) include succinic anhydride, methylsuccinic anhydride, dimethylsuccinic anhydride, ethylmethylsuccinic anhydride, glutaric anhydride, methyl glutaric anhydride, adipic anhydride, phenyl succinic anhydride, phenyl glutaric anhydride, as well as diglycolic anhydride, methyl diglycolic anhydride, dimethyl diglycolic anhydride, ethyl diglycolic anhydride, vinyl diglycolic anhydride, allyl diglycolic anhydride, and divinyl diglycolic anhydride. These may be used singly or in combination of two or more. As the cyclic carboxylic anhydride, diglycolic anhydride, succinic anhydride, and glutaric anhydride are preferable, and diglycolic anhydride is more preferable, from the viewpoints of further suppressing the increase in internal resistance of the non-aqueous electrolyte secondary battery, and the like.

The content of the cyclic carboxylic anhydride in the non-aqueous electrolyte is preferably in the range of 0.1% by mass or more and 2.5% by mass or less, and more preferably in the range of 0.2% by mass or more and 1.5% by mass or less, from the viewpoint of further suppressing the increase in internal resistance of the non-aqueous electrolyte secondary battery, and not hindering the occlusion/release of lithium ions of the active material.

### [Separator]

As the separator, for example, a porous sheet having ion permeability and insulating property is used. Specific examples of the porous sheet include a microporous thin film a woven fabric, and a non-woven fabric. As the material of the separator, olefin-based resins such as polyethylene and polypropylene, cellulose, and the like are suitable. The separator may be a laminate having a cellulose fiber layer and a thermoplastic resin fiber layer containing an olefin-based resin. In addition, a multilayer separator including a polyethylene layer and a polypropylene layer may be used, and a separator applied with a material such as an aramid-based resin or a ceramic on the surface thereof may be used.

### EXAMPLES

Hereinafter, the present disclose will be described in more detail with reference to Example, and the present disclose is not limited to the following Example.

### Example 1

### [Production of Positive Electrode]

As the positive electrode active material, the lithium composite oxide represented by the general formula, LiNi_{0.8}Co_{0.15}Al_{0.05}O₂ was used. One hundred % by mass of the positive electrode active material, 1% by mass of acetylene black as the conductive material, and 0.9% by mass of polyvinylidene fluoride as the binder were mixed and N-methyl-2-pyrolidone (NMP) was added thereto to prepare a positive electrode mixture slurry. The positive electrode mixture slurry was then applied to both surfaces of a 15-μm thick positive electrode current collector made of aluminum by a doctor blade method, and the coating film was subjected to rolling to form 70-μm thick positive electrode active material layer on both surfaces of the positive electrode current collector. The resultant was used as the positive electrode.

### [Production of Negative Electrode]

Coke and pitch binder were pulverized and mixed, and fired at 1000° C. and then graphitized at 3000° C. The resultant was pulverized by a ball mill in an N₂ atmosphere, and the obtained powder was classified to obtain graphite a1. As a result of measurement with a specific surface area measuring apparatus (Macsorb (R) HM model-1201, manufactured by Mountech Co., Ltd.) and a laser diffraction/scattering particle size distribution measuring apparatus (MT3000, manufactured by Microtrac Bell Co., Ltd.), the BET specific surface area of graphite a1 was 1.0 m²/g, and the volume average particle size of graphite a1 was 16.1 μm. One hundred parts by mass of graphite a1, 1 part by mass of carboxymethyl cellulose (CMC) as a thickener, and 1 part by mass of styrene-butadiene copolymer (SBR) as a binder were mixed, and water is added thereto to prepare a negative electrode mixture slurry. The negative electrode mixture slurry was then applied to both surfaces of a 10-μm thick negative electrode current collector made of copper by the doctor blade method, and the coating film was subjected to rolling to form 80-μm thick negative electrode active material layer on both surfaces of the negative electrode current collector. The resultant was used as the negative electrode.

### [Preparation of Non-Aqueous Electrolyte]

Ethylene carbonate (EC), methyl ethyl carbonate (EMC), and dimethyl carbonate (DMC) were mixed in a volume ratio of 30:30:40 (at room temperature). In the mixed solvent, LiPF₆ was dissolved in an amount such that the concentration in the non-aqueous electrolyte to be prepared was 1.3 mol/L, and diglycolic anhydride was further dissolved therein in an amount such that the concentration in the non-aqueous electrolyte to be prepared was 0.3% by mass, and the non-aqueous electrolyte was thus prepared.

### [Production of Non-Aqueous Electrolyte Secondary Battery]

Each of the above positive electrode and negative electrode was cut into a predetermined dimension, and then an aluminum lead and a nickel lead were respectively attached to the positive electrode and the negative electrode, and the positive electrode and the negative electrode were wound via a polyethylene separator to produce a wound electrode assembly. The electrode assembly was accommodated in a bottomed-cylindrical battery case main body having an outer diameter of 18 mm and a height of 65 mm, the above non-aqueous electrolyte solution was injected therein, the opening of the battery case main body was sealed with a gasket and a sealing assembly to produce a 18650 type cylindrical non-aqueous electrolyte secondary battery A1.

### Comparative Example 1

The graphitized product obtained by the graphite treatment in Example 1 was pulverized by a roller mill in an air atmosphere, and the obtained powder was classified to obtain graphite b1. As a result of the measurement in the same manner as the graphite a1, the BET specific surface area of the graphite b1 was 3.9 m²/g, and the volume average particle size of the graphite b1 was 22 μm. A negative electrode was produced in the same manner as in Example 1 except that the graphite b1 was used instead of the graphite a1 in the production of the negative electrode. In addition, in the preparation of the non-aqueous electrolyte, a non-aqueous electrolyte was prepared in the same manner as in Example 1 except that diglycolic anhydride was not added. Subsequently, a cylindrical non-aqueous electrolyte secondary battery B1 was produced in the same manner as in Example 1 except that the negative electrode and the non-aqueous electrolyte were used.

### Comparative Example 2

A negative electrode was produced in the same manner as in Example 1 except that the graphite b1 was used instead of the graphite a1 in the production of the negative electrode. Subsequently, a cylindrical non-aqueous electrolyte secondary battery B2 was produced in the same manner as in Example 1 except that the negative electrode was used.

### Comparative Example 3

In the preparation of the non-aqueous electrolyte, a non-aqueous electrolyte was prepared in the same manner as in Example 1 except that diglycolic anhydride was not added. Subsequently, a cylindrical non-aqueous electrolyte secondary battery B3 was produced in the same manner as in Example 1 except that the non-aqueous electrolyte was used.

### [Measurement of Internal Resistance (Direct Current Resistance)]

The direct current resistance of each battery of Example and Comparative Examples was measured by the following procedure. Each battery was charged until the battery voltage reached 4.1 V at a constant current of 0.3 It and an ambient temperature of 25° C., and then charging was continued until the current value reached 0.05 It at a constant voltage. Subsequently, discharging was performed at a constant current of 0.3 It for 1 hour and 40 minutes to obtain SOC of 50%. Voltage data was obtained when discharge currents of 0 A, 0.1 A, 0.5 A, and 1.0 A were applied for 10 seconds to each battery having the 50% of SOC. The data of the voltage value after 10 seconds against the applied discharge current value was linearly approximated by the method of least squares, and the value of direct current resistance was calculated from the absolute value of the slope of the line. One It is a current value for discharging the battery capacity in 1 hour.

Each of non-aqueous electrolyte secondary batteries in Example and Comparative Examples was charged at a constant current of 0.5 It and an ambient temperature of 45° C. until the voltage reached 4.1 V. and then constant-current discharging was performed at a constant current of 0.5 It until the voltage reached 3.0 V. This charge-discharge cycle was performed for 100 cycles. Thereafter, the SOC of each battery was set to 50% as described above, and voltage data was obtained when discharge currents of 0 A, 0.1 A, 0.5 A, and 1.0 A were applied to each battery of 50% of SOC for 10 seconds, and the value of direct current resistance of each battery was calculated. For each battery, the ratio (percentage) of the value of direct current resistance after 100 cycles to the value of direct current resistance after the first charge-discharge cycle was calculated as the resistance increase rate after the charge-discharge cycle of each battery.

### [Charge-Discharge Cycle Test]

For each of the non-aqueous electrolyte secondary batteries in Example and Comparative Examples, 100 cycles of charge-discharge cycles as the above internal resistance measurement were performed. The capacity retention rate was calculated by the following formula. This value is higher, indicating that the deterioration of the charge-discharge cycle characteristics is more suppressed.

Capacity retention rate=(Discharge capacity at 100 cycles)/(Discharge capacity at the first cycle)×100

Table 1 shows the results of the BET specific surface area of graphite used as the negative electrode active material, the content of diglycolic anhydride based on the non-aqueous electrolyte, the initial value of direct current resistance, resistance increase rate after 100 cycles, and the capacity retention rate after 100 cycles for each of the non-aqueous electrolyte secondary batteries in Example and Comparative Examples 1 to 3. The initial value of direct current resistance of each of the non-aqueous electrolyte secondary batteries in Example and Comparative Examples 1 to 3 represents the ratio (percentage) to the initial value of direct current resistance of the non-aqueous electrolyte secondary battery in Comparative Example 1.

TABLE 1

| | BET | | Direct current resistance | | Capacity retention |
|---|---|---|---|---|---|
| | specific | | | After charge- | rate after charge- |
| | surface area | Content | Initial | discharge | discharge |
| | of graphite | of DGA | value | cycle test | cycle test |
| | [m²/g] | [% by mass] | [%] | [%] | [%] |
| Example 1 | 1.4 | 0.3 | 96.4 | 103.8 | 97.5 |
| Comparative | 3.9 | — | 100 | 101.2 | 95.5 |
| Example 1 | | | | | |
| Comparative | 3.9 | 0.3 | 96.1 | 103.3 | 95.7 |
| Example 2 | | | | | |
| Comparative | 1.4 | — | 97.0 | 104.0 | 97.4 |
| Example 3 | | | | | |

DGA: diglycolic anhydride

As shown in Table 1, the non-aqueous electrolyte secondary batteries in Example 1 and Comparative Example 3 with the graphite a1 having a BET specific surface area of 2 m/g or less indicated higher value of capacity retention rate after the charge-discharge cycle test, as compared with the non-aqueous electrolyte secondary batteries in Comparative Examples 1 and 2 with the graphite b1 having a BET specific surface area of more than 2 m²/g. The non-aqueous electrolyte secondary battery in Example 1 with the non-aqueous electrolyte containing the cyclic carboxylic anhydride represented by the formula (1) or formula (2) suppressed the increase in the film thickness since the film on the negative electrode contained a constituent component derived from the cyclic carboxylic anhydride, and showed lower internal resistance after the initial and charge-discharge cycle tests as compared with the non-aqueous electrolyte secondary battery in Comparative Example 3 with the non-aqueous electrolyte not containing the cyclic carboxylic anhydride.

On the other hand, in the non-aqueous electrolyte secondary battery in Comparative Example 2, the film containing a constituent component derived from the cyclic carboxylic anhydride was easily broken by expansion and contraction of graphite, and the amount of reformation of the film increased. As a result, the internal resistance value after the charge-discharge cycle test was higher than that in Comparative Example 1 not containing the cyclic carboxylic anhydride. Thus, as a result of synergistic effect of unique film formation by combining the graphite material having a BET specific surface area of 2 m²/g or less and the cyclic carboxylic anhydride, the internal resistance value of the battery can be lowered in the initial stage and after the charge-discharge cycle test.

1. A non-aqueous electrolyte secondary battery, comprising a positive electrode, a negative electrode, and a non-aqueous electrolyte,
wherein the negative electrode contains graphite having a BET specific surface area of 2 m²/g or less, and
the non-aqueous electrolyte contains a cyclic carboxylic anhydride represented by the following formula (1) or formula (2): 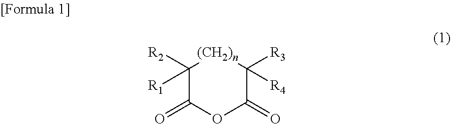
wherein n represents 0, 1, or 2, and R₁ to R₄ each independently represent a hydrogen atom, an alkyl group, an alkenyl group, or an aryl group, 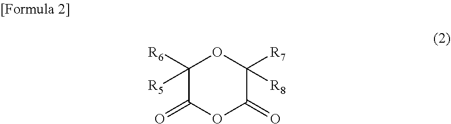
wherein R₅ to R₈ each independently represent a hydrogen atom, an alkyl group, an alkenyl group, or an aryl group.

2. The non-aqueous electrolyte secondary battery according to claim 1, wherein the cyclic carboxylic anhydride is diglycolic anhydride.

3. The non-aqueous electrolyte secondary battery according to claim 1, wherein a content of the cyclic carboxylic anhydride is 0.1% by mass or more and 2.5% by mass or less based on the non-aqueous electrolyte.

4. The non-aqueous electrolyte secondary battery according to claim 2, wherein a content of the cyclic carboxylic anhydride is 0.1% by mass or more and 2.5% by mass or less based on the non-aqueous electrolyte.
